(19) United States
(12) Patent Application Publication
(10) Pub. No.: US 2014/0019867 A1
(43) Pub. Date: Jan. 16, 2014

(54) METHOD AND APPARATUS FOR SHARING AND RECOMMENDING CONTENT

(71) Applicants: Arto Juhani Lehtiniemi, Lempaala (FI); Juha Henrik Arrasvuori, Tampere (FI); Antti Johannes Eronen, Tampere (FI)

(72) Inventors: Arto Juhani Lehtiniemi, Lempaala (FI); Juha Henrik Arrasvuori, Tampere (FI); Antti Johannes Eronen, Tampere (FI)

(73) Assignee: Nokia Corporation, Espoo (FI)

(21) Appl. No.: 13/547,705

(22) Filed: Jul. 12, 2012

(51) Int. Cl. G06F 3/048

(52) U.S. Cl. 715/738

(57) ABSTRACT

An approach is presented for sharing, discovering, and/or recommending content items associated with user information and/or other content items. A service provider determines an input from at least one user for selecting at least one object depicted in at least one media item. Further, the service provider determines at least one location associated with the at least one object. Furthermore, the service provider causes an association of the at least one user with the at least one location.

### BACKGROUND

Service providers (e.g., wireless, cellular, etc.) and device manufacturers are continually challenged to deliver value and convenience to consumers by, for example, providing compelling network services. One area of interest has been the development of services (e.g., image-sharing services, social networking services, etc.) for sharing and/or providing location-based information and recommendations, for example, via the Internet, on content, people, places or things. However, as the amount of content and information available to users increases, users are continuously challenged with finding and sorting the content and/or the associated information in an efficient manner such that the information may be shared with other users and/or be re-used by the user at a later time. Accordingly, service providers and device manufacturers face significant technical challenges to enable service providers and/or users to recommend, share, discover, and access such content in an efficient and effective manner.

### SOME EXAMPLE EMBODIMENTS

Therefore, there is a need for an approach for efficiently sharing, discovering, and/or recommending content items associated with user information and/or other content items.

According to one embodiment, a method comprises determining an input from at least one user for selecting at least one object depicted in at least one media item. The method also comprises determining at least one location associated with the at least one object. Further, the method also comprises causing, at least in part, an association of the at least one user with the at least one location.

According to another embodiment, an apparatus comprises at least one processor, and at least one memory including computer program code for one or more computer programs, the at least one memory and the computer program code configured to, with the at least one processor, cause, at least in part, the apparatus to determine an input from at least one user for selecting at least one object depicted in at least one media item. The apparatus is further caused to determine at least one location associated with the at least one object. Further, the apparatus is also caused to cause, at least in part, an association of the at least one user with the at least one location.

According to another embodiment, a computer-readable storage medium carrying one or more sequences of one or more instructions which, when executed by one or more processors, cause, at least in part, an apparatus to determine an input from at least one user for selecting at least one object depicted in at least one media item. The apparatus is further caused to determine at least one location associated with the at least one object. Further, the apparatus is also caused to cause, at least in part, an association of the at least one user with the at least one location.

According to another embodiment, an apparatus comprises means for determining an input from at least one user for selecting at least one object depicted in at least one media item. The apparatus further comprises means for determining at least one location associated with the at least one object. Further, the apparatus also comprises means for causing, at least in part, an association of the at least one user with the at least one location.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of sharing, discovering, and/or recommending content items associated with user information and/or other content items, according to an embodiment;

FIG. 2 is a diagram of the components of a processing platform, according to one embodiment, according to an embodiment;

FIGS. 3-5 are a flowchart of a processes for, at least, processing one or more media items for determining metadata, venue, and other related media items, according to various embodiments;

FIGS. 6-8 are diagrams of user interfaces utilized in the processes of FIGS. 3-5, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for sharing, discovering, and/or recommending content items associated with user information and/or other content items. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

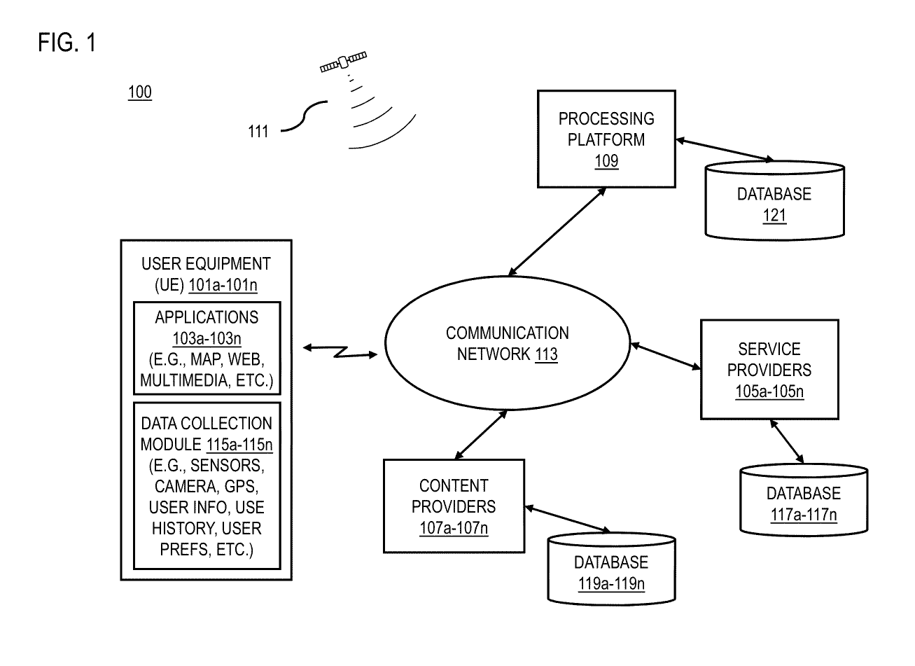

FIG. 1 is a diagram of a system capable of sharing, discovering, and/or recommending content items associated with user information and/or other content items, according to an embodiment. It is noted that mobile and computing devices in general are becoming ubiquitous in the world today and with these devices, many services are being provided. These services may include, search engines, location-based, augmented reality (AR) and the like services and applications, wherein users of the devices may capture and share content items (e.g., image, video, audio, information, etc.) with service providers and other users. In general, there are various methods for locating and obtaining content (e.g., information, media files, etc.), wherein new data technologies (e.g., data structures such as metadata) as well as new hardware features (e.g., user/device location information) provide additional capability for sharing, analyzing, determining content information (e.g., physical location of a building in a picture), and searching for other content (e.g., media, points-of-interest (POIs), etc.) associated with the content and/or user information. However, the methods to share, locate, select, and obtain additional media, information, and content are still often based on traditional approaches (e.g., manual searches using keywords or terms), which may be a time-consuming way to share, search, or browse through a collection of media and information, especially if the collection is large. However, as availability of the content and information (e.g., location-based) increases, it can be challenging for a user to efficiently share, search for and find interesting and relevant content, information, POIs, and the like based on user criteria, content, preference, profile, and the like. Further, because the traditional approaches are based on the user manually entering keywords or criteria for sharing, searching, and browsing related content, this may not always provide the most efficient, accurate, and user-friendly way to share and/or search for desired content. Therefore, new methods to share and/or search for content based on user criteria need to be further exploited to enhance user experience.

To address this problem, a system 100 of FIG. 1 introduces the capability for users to share content (e.g., media items) and request for additional content (e.g., media items, information, etc.) based on the shared content and/or the user criteria (e.g., user location, user profile, user preference, etc.) More specifically, the system 100 provides the capability for users to share content (e.g., media items) and/or information about the content (e.g., location information), which they may have created/captured via a UE 101 (e.g., pictures, video, audio, etc.), or may be viewing (e.g., via an Internet service, in a personal album, in a shared album, etc.), and the like. Further, the user would have the capability to indicate various information about the media, for example, “I was there,” “I am there,” “I will be there,” and the like, wherein the user may utilize a UE 101 UI feature (e.g., a hardware button, a software button, a touch UI button, etc.), which may be integrated into a media viewing application (e.g., on a camera, on a television set, etc.) a web browser, and the like to provide the input. In one embodiment, once the user marks a media items (e.g., a photograph) with “I was there too,” then the system 100 causes a substantially automatic inspection of the user's media gallery (e.g., on the UE 101, at a remote storage, at service provider, etc.) for one or more media items captured before and/or after the marked media item. Further, if one or more before and/or after media items are identified, then the system 100 determines a privacy/security policy associated with the media items and/or seeks an authorization from the user in order to access the marked and/or the one or more before and/or after media items for sharing with one or more other users, service providers, content providers, and the like. In various embodiments, the system 100 utilizes a crowdsourcing method to collect various media from various users in various geographical areas.

In one embodiment, the system 100 utilizes the collected media items to provide various recommendations of media items, geographical locations, POIs, and the like to various users at and/or interested in the geographical location associated with the media items. In one embodiment, the system 100 may create one or more links via the media items between users who are associated (e.g., “also been there”) with one or more geographical locations. In one embodiment, if an actual venue (e.g. a building) can be determined from a media item, then one or more media items of the venue (e.g., published photos) and/or associated recommendations (e.g., nearby POIs) may be presented and/or supplemented via an augmented reality (e.g., 3D map) presentation. However, if the actual venue or location of the user's recommended media items cannot be determined, the media items may be presented as recommendations. In other words, the recommendations would be of POIs that other users have visited before and/or after a location determined from a media item and/or from user information (e.g., user location) being processed.

In various embodiments, the various indicators of “I was there too,” “I am there now,” “I will be there,” and the like may be implemented as a client application via a UI layer, which may be implemented in various services and/or applications that enable retrieval of metadata (e.g., location, time, type, event, etc.) associated with the content. In various embodiments, the recommendation data may be stored and shared with one or more service and/or content providers.

In various embodiments, the system 100 is capable of recommending media items (e.g., images of places) and/or information associated with POIs (e.g., on a map) to users based on one or more indicator links (e.g., “I was there too”) related to media items (e.g., images) substantially automatically selected from one or more media selections before and/or after a particular media item analyzed. In one embodiment, the system 100 requests permission from an owner of a content item (e.g., media item) for use of the content item and associated before and/or after content items available at a UE 101, a storage, a service provider, a content provider, and the like. In one example, the user may allow sharing of user location information (indicating that he “was there too”), but may also refuse the system 100 (e.g., a service provider) to use the actual content items the user has created/captured, wherein a service provider may use the actual location information to obtain generic media items (e.g., publically available) associated with the locations to be included in the recommendations.

In one use case scenario, a user submits an indication of “I was there too” associated with one or more initial content items of the user, wherein the system 100 analyzes metadata (e.g., from the user's UE 101) of the one or more content items and determines other relevant content items; for example, other content items captured, created, listed, and/or stored before and/or after the one or more initial content items. In one embodiment, the one or more other content items may be content items captured/created at one or more different locations immediately before and/or immediately after the one or more initial content items' location (i.e. not exactly at the same location). In one embodiment, the one or more other content items may not be located (e.g., stored, listed, etc.) immediately before and/or immediately after the one or more initial content items. In various embodiments, the one or more other content items may be determined based, at least in part, on one or more metadata associated with the one or more initial content items; for example, information on content creation/capture/storage date, time, location, user, listing, theme, event, and the like.

In one example, a user John is viewing pictures of the Empire State Building in N.Y. via a website and wishes to indicate that he was there, too, (e.g., “I was there too”) several months ago. In one embodiment, John utilizes a UI feature button (e.g., hardware, software, etc.) “I was there too” available on his UE 101. Further, the system 100 requests for his permission to use the pictures in recommendations for other users. Furthermore, upon John's authorization, the system 100 analyzes/searches for suitable recommendation content items available at John's UE 101, a remote storage device/service, and the like. In one example, the system 100 determines one or more content items associated with Madison Square Garden N.Y., which John visited before the Empire State Building and Central Park, which John visited after the Empire State Building. Accordingly, the system 100 may utilize the crowdsourcing mechanism to determine popular and relevant routes (e.g., on a map) in various geographical locations and/or generate a collective media items (e.g., photo journeys) of locations people typically visit before and/or after visiting the Empire State Building in N.Y.

In another example, user John is viewing media items at a social networking site (e.g., Facebook®) where he sees a media item (e.g., a video, an image, etc.) of the Empire State Building in N.Y., posted by another user, when he remembers his visit of the Empire State Building during his last trip and utilizes a user interface (UI) indicator (e.g., click a button) in a media viewing application to mark/indicate the media item that “I was there too.” In one embodiment, a service provider (e.g., a processing center) analyzes the media item (e.g., metadata) and determines venue of the marked media item. In one embodiment, if metadata for the media item is not available, then the service provider may utilize one or more object recognition technique to determine the venue in the marked media item. Further, the service provider may request permission from John to search through John's media collection (e.g., images, video, etc.), for example, on his UE 101 and/or at a remote storage site/service (e.g., another UE 101, a cloud-based service, etc.) for media items and/or metadata associated with locations near the Empire State Building he has taken in that venue. In one example, the service provider identifies one or more media items in John's media collection, which include an image of the Empire State Building. Further, the service provider may analyze and/or retrieve one or more media items before and/or after the marked media (e.g., the Empire State Building image) from the media collection. In one embodiment, based on the analysis, the service provider determines if the before and/or the after media items are associated with the marked media items, for example, located nearby, similar themes (e.g., museums, parks, etc.), and the like. Furthermore, the service provider may utilize the marked media item and the one or more before and/or after media items to provide one or more recommendation services to one or more users. For example, the one or more recommendations may suggest visiting the Madison Square Garden, the Empire State Building, and the Central Park locations in N.Y., wherein additional information may be included in the recommendation, for example, how many other users have visited the venues as suggested (e.g., in the same order) which may or may not include information about the other users.

In another example, user Mina is watching a TV show, which depicts one or more media items (e.g., images, video, audio, etc.) of a certain venue, e.g., the Rockefeller Center in N.Y., when the user Mina clicks the “I was there too” button to mark the media item. Further, the service provider analyzes the marked media item, determines the venue, and searches through Mina's media collection for other media items associated with the determined venue. The service provider identifies one or more media items in Mina's media collection that include the Rockefeller Center and retrieves one or more before and/or after media items associated with the marked media item (e.g., the Rockefeller Center). In one example, the service provider includes various number of media items in a recommendation service to one or more other users, which include one or more media items of the Central Park, the Rockefeller Center, and the Metropolitan Museum of Art in N.Y., indicating that at least one user has visited the three venues in succession.

In another example, a user Mike is visiting the Empire State Building in N.Y., and requests from a service provider (e.g., a recommendation service) for suggested places to visit. The service provider utilizes visiting information/venue collected from the users John and Mina to provide one or more recommendations to user Mike; for example, suggestion to visit the Madison Square Garden, the Central Park, the Rockefeller Center, and the Metropolitan Museum of Art; wherein the recommendation may include one or more media items (e.g., publicly available, by other users, etc.) associated with the suggested venues, additional information/description of the venues, and/or travel route options (e.g., on a map) to the venues.

As discussed earlier, when a user marks an initial media item to indicate “I was there too,” an application and/or a service provider inspects the user's media collection (e.g., with the user's consent) in order to analyze and discover other relevant media items captured/created before and/or after the marked initial media item. For example, metadata of the marked initial media item is retrieved and/or analyzed for determining other media items associated with the marked initial media item for utilization by one or more service providers (e.g., a cloud-based recommendation service). In various embodiments, the application and/or the service provider may utilize one or more algorithms, rules, criteria, and the like for determining one or more relevant media items associated with one or more marked media items. For example, potential media items from user's device and/or storage are analyzed by the application and/or service provider to determine suitability for use in creating one or more recommendations for one or more users. In one embodiment, the application and/or the service provider determines physical distance between a marked venue (e.g., a first location) and a potential venue (e.g., a second location). For example, a distance criterion may require the potential venues to be less than one or two kilometers in an urban area (e.g., suitable distance for a tourist to walk in a city center). In another embodiment, the criteria may require a potential media item to be within a certain time interval from a marked initial media item, for example, one or more pictures taken within one hour before and/or after the marked media item. In one embodiment, the criteria may require that the potential venues contain the same area or theme as the marked media item (e.g., within Manhattan area where media items (e.g., of POIs) outside the Manhattan area may not be included). In one embodiment, a criterion may be that metadata of a media item is to contain at least one identical user device information (e.g., Bluetooth® ID) device information.

However, in general, not all media items associated with a user and/or a UE 101 are relevant or useful as recommendations of locations and venues for other users, for example, some of the media items may just be meaningful for a user having captured/created the media items, wherein the media items may contain, for example, images of the user and his friends, which the application and/or the service provider may choose to exclude those media items.

In various embodiments, the application and/or the service provider may compare location information of a media item to known POIs (e.g., tourist attraction locations), which may also be present in other media items available from other users and/or content providers.

In one embodiment, the service provider may determine current location information of a user (e.g., a restaurant, a bar, etc.) and present one or more recommendations of different type of POIs; for example, a museum, a city park, a golf course, and the like. In one embodiment, media items in a user's media collections may not match to any known POIs, but may still be present in various users' media collection, which may indicate a new and interesting venue to be considered for recommendation. In this case, the service provider may include the media items in its recommendations to other users. Further, information of media items not utilized in recommendations may be noted and stored if one or more criteria (e.g., location, time, venue, etc.) match a request. In one embodiment, if media items associated with a certain unknown venue repeat in different media collections, then the application and/or the service provider may prompt one or more users associated with the media items of the unknown venue with a question (e.g., “What is this place?”) in order to determine/collect more information about the media items and the venue, wherein the collected information of potentially new POIs may be stored and/or shared with various users, service and/or content providers.

In one embodiment, a user may include theme information (e.g., business, holiday, short trip, etc.) in one or more requests for one or more recommendations so that the recommendations may be optimized based on the theme information. Further, a user's media/content collection may be classified, grouped, and/or assigned to a specific theme based on metadata (e.g., time of a day) associated with the items in the collection. Similarly, in another embodiment, a user indicating “I was there” may include theme information (e.g., “business,” “pleasure,” “vacation,” etc.) related to the indicated media file. The theme information may be associated with the media items obtained from the user's content collection. In another embodiment, the system 100 may attempt to substantially automatically determine the theme information, which may be applied to media items when presented to the users (e.g., when providing recommendations) and/or when receiving media items from the users (e.g., when receiving recommendation requests). The substantially automatic recognition of a the theme information may be accomplished via various methods, for example, by accessing calendar information of the user to determine whether a time corresponding to a capture of a media item is marked as “business,” “pleasure,” “vacation,” and the like. In one embodiment, information about persons accompanying a user during a capture, generation, or reception of a content item may be used to determine the theme information associated with the content item. For example, metadata of one or more content items may include information of user devices (e.g., Bluetooth® device identifiers) associated with one or more persons who may be associated with the user (e.g., wife, children, other family members, co-workers, classmates, and the like), wherein the theme of the one or more content items may be determined and/or classified as a family event (e.g., holiday, vacation, family reunion, etc.), a business event (e.g., business meeting), a school event (e.g., a field trip), and the like. In one embodiment, a theme recognition method may utilize one or more device identifiers (e.g., Bluetooth®, near filed communication (NFC), radio-frequency identification (RFID), etc.) detected to be nearby a user device, for example, when a user of the user device is requesting for a recommendation. In one use case scenario, a user is in New York City and submits a request for one or more recommendations, when a scan of a local area network (e.g., Bluetooth®, RFID) may be used to obtain a list of identifiers of nearby devices to determine a theme. In one embodiment, when a user indicates “I will be there,” the system 100 may enquire additional information from the user (e.g., time, date, etc.), wherein based on the additional information, the system 100 may determine and/or obtain other information from a user device application (e.g., a calendar) for determining a type (e.g., theme) of a possible event identified in/by the application (e.g., a business trip, vacation time, personal time, etc.).

In another embodiment, in addition to and/or instead of collecting media items, one or more information items associated with the media items (e.g., global positioning system (GPS) location coordinates) are determined and collected, wherein one or more recommendations may be defined as POIs corresponding to the one or more information items (e.g., GPS coordinates). In various embodiments, in addition to and/or instead of original media items, the application and/or the service provider may utilize publicly available related media items (e.g., 3D map objects) of POIs collected from one or more content providers (e.g., image sharing services).

In various embodiments, certain media items with incomplete metadata may still be utilized along with other media items which have proper metadata. For example, a list of media items includes: media item 1, media item 2, media item 3 missing one or more metadata items (e.g., location information), and media item 4, wherein the media item 2 and media item 4 are determined to be suitable for recommendations; however, the media item 3 is missing the location information. Nevertheless, the media item 3 may still be used in recommendations since its surrounding media items 2 and 4 have sufficient metadata, wherein content (e.g., file) information, such as date/time, indicate that media item 3 was created/captured/stored at some time between media items 2 and 4.

In one embodiment, a UI indicator feature (e.g., an “I was there too” button) may also be incorporated and utilized in various digital media, for example, digital newspaper and magazines, digital image frames, and the like.

In various embodiments, various spatial and UE 101 sensors and/or radio receivers such as Bluetooth® may be utilized to identify one or more individuals present in one or more media items (e.g., a photo, a video, etc.) and/or nearby a certain location (e.g., in a park, at a restaurant, aboard a ship, etc.) where the one or more media items were captured/created. For example, a user device (e.g., a mobile phone, a camera, a tablet, etc.) may detect and collect the Bluetooth® device identifiers of various nearby devices about the time of capturing one or more media items and then associate the identifiers with the one or more captured images. Further, the application and/or the service provider may associate the one or more individuals with the one or more media items. For example, users associated (e.g., owning) with the various devices corresponding to the detected Bluetooth® device identifiers may be associated with the one or more media items. Furthermore, if one of the one or more individuals happen to view the one or more media items later, for example, at a social networking site (e.g., Facebook®, Flickr®, etc.), the application and/or the service provider may enquire from the one individual “You were there too, weren't you?” thus prompting the one individual to indicate that “I was there too” and potentially obtain access to related media items associated with the one or more media items, for example, during the same event.

In one embodiment, the application and/or the service provider may add an image of a user (e.g., an avatar as small thumbnails) into a media item (e.g., at a social networking site), which the user may be associated by indicating that “I was there too.” In one embodiment, a user's profile at a social networking site (e.g., Facebook®) include one or more indicators (e.g., thumbnails, avatars, “I was there too,”) associating the user with places, which may function as links to actual related content and media items.

In one embodiment, media items from one or more users may be presented via a map application, an augmented reality application, a mixed reality application, a virtual reality application, and the like.

As discussed above, the system 100 may provide various benefits and advantages to the users utilizing the methods of the system 100. For example, the system 100, at least, provides an efficient mechanism to link a user's media collection to potentially related media items available via a communication channel (e.g., the Internet), wherein the user may initiate one or more indicators of “I was there too,” “I am there now,” “I will be there,” and the like. Further, the system 100 provides easy but yet efficient methods for determining relevant user content to be used as recommendations with or without using object detection algorithms on the media content. Furthermore, the system 100 enables recommendations including media content with incomplete metadata in a user's media collection; enables media content sharing and/or recommendations, which otherwise may not be shared and/or utilized in determining various recommendations to other users. Additionally, utilizing media items from each user of a venue or using the location metadata obtained from a user's media collection and then utilizing publically available media items included in a recommendation can provide user privacy protection. Moreover, the system 100 may utilize crowdsourcing to obtain extensive media collection (e.g., photo journeys) of nearby locations. Further, it provides the capability for the users of social networking sites to visually list venues they have visited.

In various embodiments, there may be different reasons and/or options for the users to participate in the system 100, for example, one or more service providers may offer one or more rewards and benefits to the users: for being active contributors; for posting recommendation related information to social networking sites; can receive potential recommendations from other users who have visited same venues; may receive notifications of available content by other users associated with a same venue at approximately same time, which may be a relevant addition to the user's media collection (e.g., shared content of friends and other people from the same event).

As shown in FIG. 1, in one embodiment, the system 100 includes user equipment (UE) 101a-101n (also collectively referred to as UE 101 and/or UEs 101), which may be utilized to execute one or more applications 103a-103n (also collectively referred to as applications 103) including games, social networking, web browser, media application, user interface (UI), map application, web client, etc. to communicate with other UEs 101, one or more service providers 105a-105n (also collectively referred to as service providers 105), one or more content providers 107a-107n (also collectively referred to as content providers 107), a processing platform 109, one or more GPS satellites 111, and/or with other components of the system 100 directly and/or via communication network 113. In one embodiment, the UEs 101 may include data collection modules 115a-115n (also collectively referred to as data collection module 115) for determining and/or collecting data associated with the UEs 101, one or more users of the UEs 101, applications 103, one or more content items, and the like. In addition, the UE 101 can execute an application 103 that is a software client for storing, processing, and/or forwarding one or more information items to other components of the system 100.

In one embodiment, the service providers 105 may include and/or have access to one or more database 117a-117n (also collectively referred to as database 117), which may include various user information, content items, user profiles, user preferences, one or more profiles of one or more user devices (e.g., device configuration, sensors information, etc.), service provider information, other service provider information, and the like.

In one embodiment, the content providers 107 may include and/or have access to one or more database 119a-119n (also collectively referred to as database 119), which may store, include, and/or have access to various content items. For example, the content providers 107 may store content items (e.g., at the database 119) provided by various users, various service providers and the like. In various embodiments, the content providers 107 may sort, manage, store, and/or make the content items available based on various parameters, for example, location information (e.g., of a submitter, of a content item, of a requestor, etc.), sequential order, content type, date/time of content creation and/or submission, date/time of a content request, and the like. In various embodiments, the content may include media items, maps, metadata (e.g., location information, content type, content creator, etc.) associated with the content items, various points of interest (POIs), and the like.

In one embodiment, the processing platform 109 may include and/or have access to a database 121 to access and/or store information associated with the users, content, UEs 101, media, media recognition models, and the like. In one embodiment, the service providers 105 may obtain content (e.g., media content, POI information, etc.) from the content providers 107 and then offer the content to the UE 101, to the processing platform 109, and/or to one or more other services or entities of the system 100. It is noted that the processing platform 109 may be a stand-alone entity in the system 100, a part of the service providers 105, a part of the content provider 107, included within the UE 101 (e.g., as part of the applications 103), or a combination thereof.

In one embodiment, the UE 101 includes a location module/sensor that can determine the UE 101 location (e.g., a user's location). The UE 101 location can be determined by a triangulation system such as a GPS, assisted GPS (A-GPS), Cell of Origin, wireless local area network triangulation, or other location extrapolation technologies. Standard GPS and A-GPS systems can use the one or more satellites 111 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., WLAN) connection to determine the UE 101 location information, for example, from an Internet source (e.g., a service provider).

In one embodiment, the service providers 105 may include one or more service providers offering one or more services, for example, online shopping, social networking services (e.g., blogging), media upload, media download, media streaming, account management services, or a combination thereof. Further, the service providers 105 may conduct a search for content, media, information, and the like associated with one or more users and/or one or more products. In certain embodiments, the processing platform 109 is implemented as a collection of one or more hardware, software, algorithms, firmware, or combinations thereof that can be integrated for use with the service providers 105 and/or with the content providers 107. In various embodiments, the processing platform 109 can be maintained on a network server, while operating in connection with the service providers 105 and/or with the content providers 107 as an extensible feature, a web-service, an applet, a script, an object-oriented application, or the like to enable searching for and/or processing of the social networking information. Further, the processing platform 109, the service providers 105, and/or the content providers 107 may utilize one or more service application programming interfaces (APIs)/integrated interface, through which communication, media, content, and information (e.g., associated with users and products) may be shared, accessed and/or processed.

In one embodiment, the system 100 determines an input from at least one user for selecting at least one object depicted in at least one media item. In one embodiment, the service provider 105 and/or the processing platform 109 receive an input from a user including a media item (e.g., a digital picture file) and an indicator which selects/marks an object, for example a building, in the media item. In one example, the media item may include several objects in the media item, wherein the user may select any of the objects. In one embodiment, the media item includes metadata providing one or more information items about the media item and/or one or more objects included in the media item. For example, the metadata may indicate date, time, location information, environmental information, and the like about the media item.

In one embodiment, the system 100 determines at least one location associated with the at least one object. In one embodiment, the service provider 105 and/or the processing platform 109 may analyze the metadata for determining a location associated with the media item and/or the object in the media item. For example, the metadata may include GPS information, cell ID information, and the like. In one embodiment, the service provider 105 and/or the processing platform 109 may utilize an object recognition technique to determine what the object is (e.g., the Golden Gate Bridge) and then determine a location for the object (e.g., San Francisco). In one embodiment, the , the service provider 105 and/or the processing platform 109 may utilize a database for comparing the object selected in the media item to one or more known objects in the database.

In one embodiment, the system 100 causes, at least in part, an association of the at least one user with the at least one location. In one embodiment, the service provider 105 and/or the processing platform 109 create a link between the user and the determined location, for example, in one or more databases. In one example, the user may be linked to one or more locations determined from one or more media items, one or more user information, one or more UE 101 information, and the like, wherein the link/association information may be stored in one or more databases (e.g., at a UE 101, at one or more service providers, etc.) In one embodiment, the user is associated/linked with the media item and/or one or more objects in the media item.

In one embodiment, the system 100 determines one or more other media items based, at least in part, on the at least one location, wherein the one or more other media items are from one or more media collections associated with the at least one user. In one embodiment, the service provider 105 and/or the processing platform 109 access one or more content storage devices and determine one or more other media items associated with the determined location. For example, the user may have access to a media sharing/storage device/service where the user is associated (e.g., owns) one or more media items. In one embodiment, the one or more other media items include metadata for indicating location information.

In one embodiment, the system 100 determines the one or more other media items based, at least in part, on a physical proximity criterion, a temporal proximity criterion, a thematic proximity criterion, a metadata similarity criterion, or a combination thereof. In one embodiment, the one or more other media items are determined based on a physical proximity of objects in the one or more other media items to the location of the object in the media item, to the location information of the user, and the like. In one embodiment, the one or more other media items are determined based on their time/chronological proximity to the media item. For example, two pictures in a database having close timestamps (e.g., within one minute of each other) may be considered having close temporal proximity and/or close in physical location. In one embodiment, the one or more other media items may be determined based on having a similar theme to the media item, for example, media items including scenes of a cruise ship. In one embodiment, the one or more other media items may have similar metadata as the media item. For example, the metadata may include similar location information, date, time, user device information, user information, user comment information or tags, and the like.

In one embodiment, the system 100 determines one or more other respective associations between (a) the at least one media item, the one or more other media items, or a combination thereof; and (b) one or more other users. In one embodiment, the service provider 105 and/or the processing platform 109 determines one or more other associations, for example, based on the metadata, venue of the media items and/or the other media item, the user profile, user preferences, and the like.

In one embodiment, the system 100 causes, at least in part, a recommendation of the one or more other media items, the at least one location, one or more other locations associated with the one or more other media files, or a combination thereof to the one or more other users. In one embodiment, the service provider 105 and/or the processing platform 109 present/recommend the one or more other media items to one or more other users. For example, a service provider may access one or more other media items at a user device and then present the one or more other media items to one or more other users so that the one or more other users may utilize the one or more other media items as part of their media collection, for planning a visit, and the like. In one embodiment, the service provider 105 and/or the processing platform 109 may recommend one or more other locations, one or more other POIs, and the like to the one or more other users. For example, a recommendation to visit a certain location, a certain POI, and the like.

In one embodiment, the system 100 determines at least one capture time of the at least one media item. In one embodiment, the service provider 105 and/or the processing platform 109 may determine a capture time, date (e.g., in a camera) of a media item, wherein the capture time may be determined from metadata associated with the one or more media items.

In one embodiment, the system 100 determines the one or more other media items captured before, after, or a combination thereof of the at least one capture time. In one embodiment, the service provider 105 and/or the processing platform 109 may access a media collection (e.g., on a UE 101, at a media service, a digital album, etc.) and determine one or more other media items captured before and/or after the one media. For example, a media collection may include one or more media items captured before and/or after a selected media item based on listings, locations, themes, events, and the like.

In one embodiment, the system 100 determines one or more before locations associated with the one or more other media items captured before the at least one capture time, one or more after locations associated with the one or more other media items captured after the at least one capture time, or a combination thereof. In one embodiment, the location information of the one or more before and/or after media items may be determined based on metadata associated with the media item and the one or more other media items. In one embodiment, the user may include one or more information items associated with the media item, the before and/or after media items.

In one embodiment, the system 100 causes, at least in part, a recommendation of (a) the one or more before locations, the one or more after locations, or a combination thereof (b) the one or more other media items associated with the one or more before locations, the one or more after locations, or a combination thereof or (c) a combination thereof to the one or more other users. In one embodiment, the service provider 105 and/or the processing platform 109 may determine location information, event, theme, and the like for recommending one or more other media items, one or more locations, one or more events, and the like to one or more other users, wherein the one or more other users may be associated with the one or more locations, the one or more events, the one or more themes, and the like.

In one embodiment, the system 100 processes and/or facilitates a processing of the one or more other media items, the at least one location, the one or more other locations associated with the one or more other media files, or a combination thereof to determine a correlation to (a) one or more points of interest, (b) one or more contextual attributes of the at least one user, the one or more other users, or a combination thereof or (c) a combination thereof, wherein the recommendation of the one or more other media items, the at least one location, the one or more other locations associated with the one or more other media files, or a combination thereof is based, at least in part, on the correlation. In various embodiments, the service provider 105 and/or the processing platform 109 may determine one or more information items associated with the one or more media items, the one or more locations, one or more user information items (e.g., user profile, user preference, etc.), and the like and determine one or more comparable information items between the determined information, one or more POIs, one or more information associated with the user (e.g., user profile, nature of user travel, nature of user location, user preference, etc.) for the one or more other user based on the determined information.

In one embodiment, the system 100 determines that the one or more other media items are not associated with any location information. In one embodiment, the service provider 105 and/or the processing platform 109 may access one or more media collections, wherein one or more included media items are missing all or portions of metadata (e.g., location information).

In one embodiment, the system 100 causes, at least in part, in a selection of the one or more media items based, at least in part, on a content comparison between the one or more media items and the at least one media item. In various embodiments, one or more content information items of a media item may be compared with that of one or more other media items. For example, the comparison may determine that one or more objects, users, themes, events, and the like are similar or dissimilar between the one media item and the one or more other media items.

In one embodiment, the system 100 causes, at least in part, a presentation of at least one user interface element associated with the at least one object, the at least one media item, or a combination thereof, wherein the at least one user interface includes, at least in part, a button user interface element for indicating the association. In one embodiment, the service provider 105, the processing platform 109, and/or a UE 101 may present one or more UI elements for interaction with the user, for example, a hardware button, a software button, a touchscreen button, and the like, wherein the user may utilize the UI feature to make a selection, present an input, mark a media item, and the like. For example, the button may enable the user to indicate “I have been there,” “I am there,” “I will be there,” and the like associated with media item, an object in a media item, and the like.

In one embodiment, the system 100 determines the input based, at least in part, on one or more interactions with the button user interface element. In one embodiment, the UI on the UE 101 may detect one or more inputs from the user, wherein the input may be associated with one or more media items, one or more information items, one or more use information, one or more user preferences, and the like. Further, the one or more inputs may be processed by the UE 101, the service provider 105 and/or the processing platform 109.

In one embodiment, the system 100 processes and/or facilitates a processing of the at least one media item using one or more recognition technologies to cause, at least in part, an identification of the at least one object. In one embodiment, the UE 101, the service provider 105, and/or the processing platform 109 may utilize one or more object recognition algorithms, techniques, methods, and the like for identifying one or more objects in one or more media items. For example, the one or more recognition methods may be utilized along or instead of utilizing the metadata associated with one or more media items.

In one embodiment, the processing platform 109, the service providers 105, and/or the content providers 107 may interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. It is also noted that the role of a client and a server is not fixed; in some situations a device may act both as a client and a server, which may be done simultaneously and/or the device may alternate between these roles.

By way of example, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, wrist watch, or any combination thereof, including the accessories and peripherals of these devices, or any combination thereof. It is also contemplated that the UEs can support any type of interface to the user (such as “wearable” circuitry, etc.) Further, the UEs 101 may include various sensors for collecting data associated with a user, a user's environment, and/or with a UE 101, for example, the sensors may determine and/or capture audio, video, images, atmospheric conditions, device location, user mood, ambient lighting, user physiological information, device movement speed and direction, and the like.

By way of example, the UEs 101, the service providers 105, and the content providers 107 may communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

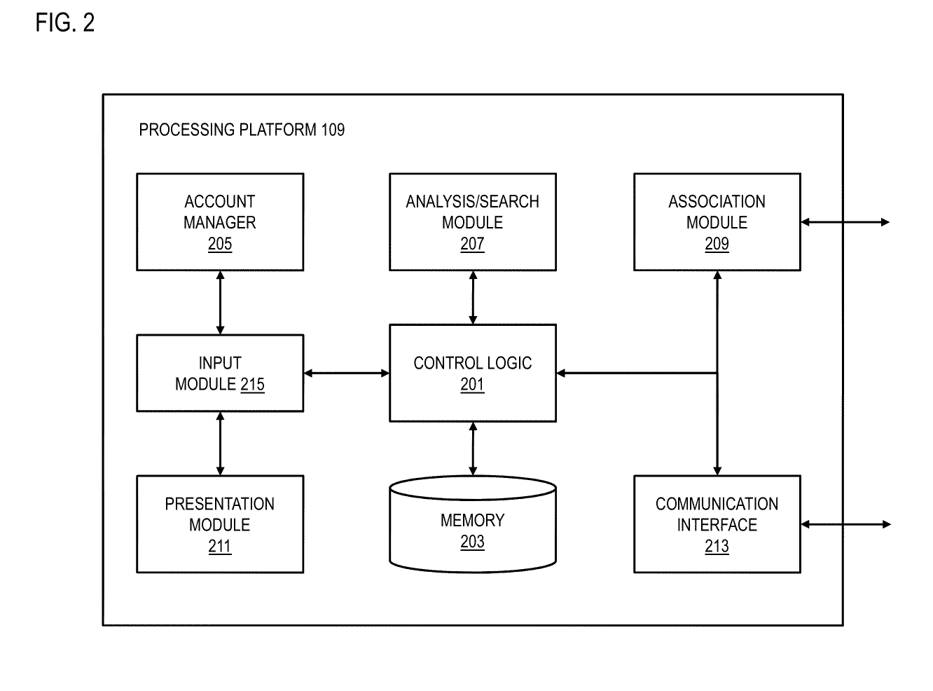

FIG. 2 is a diagram of the components of a processing platform, according to an embodiment. By way of example, the processing platform 109 includes one or more components for analyzing and processing user and/or media information. It is contemplated that the functions of these components may be combined in one or more components or performed by other components of equivalent functionality. In this embodiment, the processing platform 109 includes control logic (or processor) 201, memory 203, an account manager 205, an analysis/search module 207, an association module 209, a presentation module 211, a communication interface 213, and an input module 215.

The control logic 201 executes at least one algorithm, software, application, and the like for executing functions of the processing platform 109. For example, the control logic 201 may interact with the account manager 205 to receive a request to register a user, one or more media, content files, POI information, and/or descriptive information. The descriptive information may include user comments, experience, rating, and the like. In determining whether to complete the registration request, the account manager 205 may process information associated with the user, such as the user's account information, user status, user ranking, privacy policy, security policy, etc. If, for instance, it is determined that the user satisfies the requirements of the service provider, the account manager 205 may then register and associate the user with the at least one media item and other related information.

As such, the account manager 205 may work with the analysis/search module 207, via the control logic 201, to process the user and media item information to generate a user profile and/or add new media information to an account already associated with the user. As discussed, the media, content and information associated with a POI and/or the user may be captured (e.g., via a sound recorder, a camera, a camcorder, etc.) or retrieved from a local or remote database (e.g., a search database, a social networking database, etc.), a content provider, a user device, another service provider, and the like. In various embodiments, the analysis/search module 207 may utilize one or more algorithms/techniques for detecting objects (e.g., POIs, things, buildings, landmarks, etc.), people (e.g., facial recognition), and the like depicted in the media items. In various embodiments, the analysis/search module 207 may utilize one or more search algorithms (e.g., engines) to search for content (e.g., media items), which may be available at one or more user devices, content providers, service providers, and the like, wherein the content may be based, at least in part, on the analyzed media items received from one or more users. Further, the analysis/search module 207 may utilize metadata associated with the analyzed media items, user information, location information, and the like. The analysis/search module 207 performs various analysis based on the metadata, a presented media file, available sources for the files, and etc., so as to select other media items based on the information about the media (e.g., rendered at a UE 101).

Next, the control logic 201 may then direct the association module 209 to associate together the user, the one or more media, content files, and/or the descriptive information. Consequently, the presentation module 211 may present all or a portion of the one or more media/content and/or descriptive information to other users based, at least in part, on the privacy and/or security policies associated with the user and/or the other users. Further, the processing platform 109 may share all or a portion of the one or more media items/content and/or descriptive information with one or more service providers (e.g., social networking), content providers, and the like based, at least in part, on the privacy and/or security policies.

The control logic 201 may also utilize the communication interface 213 to communicate with other components of the processing platform 109, the UEs 101, the service providers 105, the content providers 107, and other components of the system 100. For example, the communication interface 213 may transmit a notification to a user's device to indicate whether the user request has been registered with one or more service provider. The communication interface 213 may also manage and control receiving various requests from other UEs 101, the service providers 105, the content providers 107, and/or other entities of the system 100. The communication interface 213 may further include multiple means of communication. In one use case, the communication interface 213 may be able to communicate over short message service (SMS), internet protocol, instant messaging, voice sessions (e.g., via a phone network), or other types of communication.

The input module 215 manages various types of input received via a UE 101. For example, the input module 215 manages receiving an input for selecting elements of a media item and/or metadata associated with the media item for selecting other media items based on the input. The presentation module 211 controls display of a user interface (UI) such as a graphical user interface (GUI), to convey information and to allow user to interact with a UE 101 via the interface. The presentation module 211 interacts with the control logic 201, the communication interface 213 and the analysis/search module 207 to display any information generated during their operation (e.g., displaying the media items, maps, POIs, elements of metadata, and any other information). The input module 215 may also receive an input for selecting elements of a media item and/or of metadata associated with the media item. The input may be received by a user pressing a button or an icon displayed in an area of the UI, for example, for the user to indicate “I have been there,” “I am there,” “I will be there,” and the like. The analysis/search module 207 may then search for and select other media items, information, and/or POIs based on the input.

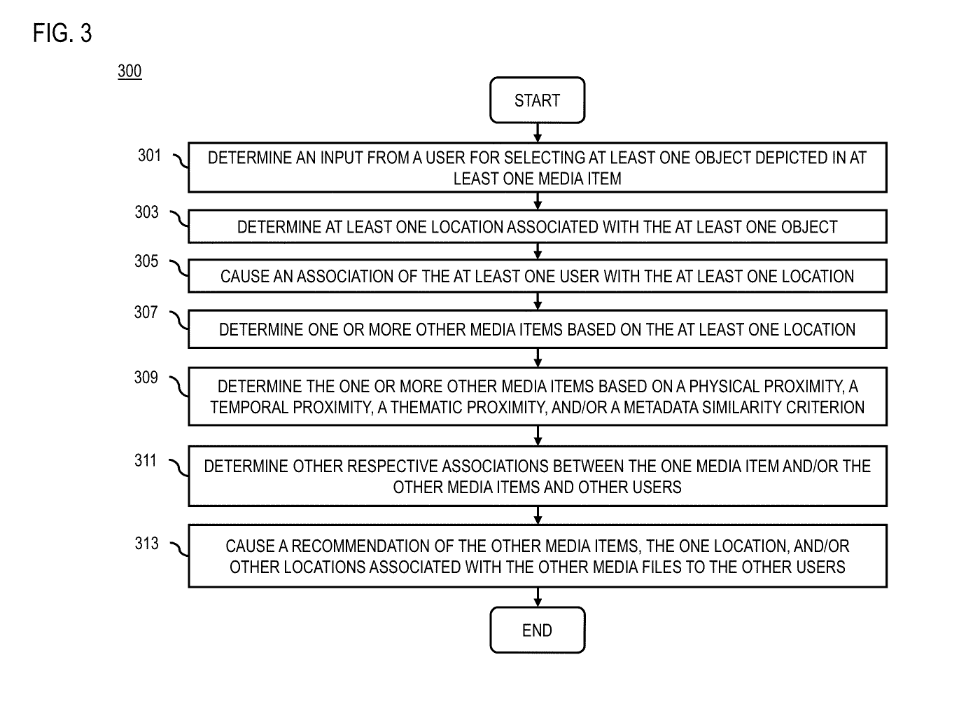

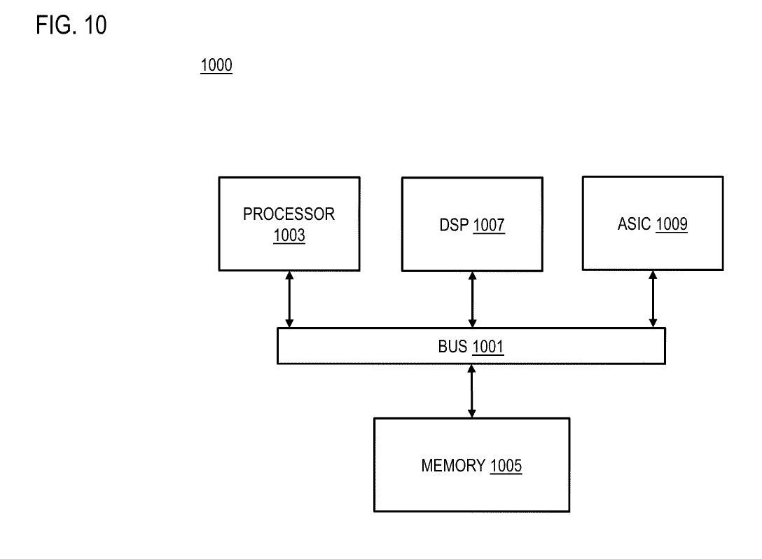

FIG. 3 is a flowchart of a process for, at least, processing one or more media items for determining metadata, venue, and other related media items, according to various embodiments. In one embodiment, the processing platform 109, the service provider 105 and/or the applications 103 perform the process 300 and are implemented in, for instance, a chip set including a processor and a memory as shown in FIG. 10. As such, the processing platform 109, the service provider 105, and/or the applications 103 can provide means for accomplishing various parts of the process 300 as well as means for accomplishing other processes in conjunction with other components of the system 100. Throughout this process, the processing platform 109 is referred to as completing various portions of the process 300, however, it is understood that other components of the system 100 can perform some of and/or all of the process steps. Further, in various embodiments, the processing platform 109 may be implemented in one or more entities of the system 100.

In step 301, the processing platform 109 determines an input from at least one user for selecting at least one object depicted in at least one media item. In one embodiment, the service provider 105 and/or the processing platform 109 receive an input from a user including a media item (e.g., a digital picture file) and an indicator which selects/marks an object, for example a building, in the media item. In one example, the media item may include several objects in the media item, wherein the user may select any of the objects. In one embodiment, the media item includes metadata providing one or more information items about the media item and/or one or more objects included in the media item. For example, the metadata may indicate date, time, location information, environmental information, and the like about the media item.

In step 303, the processing platform 109 determines at least one location associated with the at least one object. In one embodiment, the service provider 105 and/or the processing platform 109 may analyze the metadata for determining a location associated with the media item and/or the object in the media item. For example, the metadata may include GPS information, cell ID information, and the like. In one embodiment, the service provider 105 and/or the processing platform 109 may utilize an object recognition technique to determine what the object is (e.g., the Golden Gate Bridge) and then determine a location for the object (e.g., San Francisco). In one embodiment, the , the service provider 105 and/or the processing platform 109 may utilize a database for comparing the object selected in the media item to one or more known objects in the database.

In step 305, the processing platform 109 causes, at least in part, an association of the at least one user with the at least one location. In one embodiment, the service provider 105 and/or the processing platform 109 create a link between the user and the determined location, for example, in one or more databases. In one example, the user may be linked to one or more locations determined from one or more media items, one or more user information, one or more UE 101 information, and the like, wherein the link/association information may be stored in one or more databases (e.g., at a UE 101, at one or more service providers, etc.) In one embodiment, the user is associated/linked with the media item and/or one or more objects in the media item.

In step 307, the processing platform 109 determines one or more other media items based, at least in part, on the at least one location, wherein the one or more other media items are from one or more media collections associated with the at least one user. In one embodiment, the service provider 105 and/or the processing platform 109 access one or more content storage devices and determine one or more other media items associated with the determined location. For example, the user may have access to a media sharing/storage device/service where the user is associated (e.g., owns) one or more media items. In one embodiment, the one or more other media items include metadata for indicating location information.

In step 309, the processing platform 109 determines the one or more other media items based, at least in part, on a physical proximity criterion, a temporal proximity criterion, a thematic proximity criterion, a metadata similarity criterion, or a combination thereof. In one embodiment, the one or more other media items are determined based on a physical proximity of objects in the one or more other media items to the location of the object in the media item, to the location information of the user, and the like. In one embodiment, the one or more other media items are determined based on their time/chronological proximity to the media item. For example, two pictures in a database having close timestamps (e.g., within one minute of each other) may be considered having close temporal proximity and/or close in physical location. In one embodiment, the one or more other media items may be determined based on having a similar theme to the media item, for example, media items including scenes of a cruise ship. In one embodiment, the one or more other media items may have similar metadata as the media item. For example, the metadata may include similar location information, date, time, user device information, user information, user comment information or tags, and the like.

In step 311, the processing platform 109 determines one or more other respective associations between (a) the at least one media item, the one or more other media items, or a combination thereof; and (b) one or more other users. In one embodiment, the service provider 105 and/or the processing platform 109 determines one or more other associations, for example, based on the metadata, venue of the media items and/or the other media item, the user profile, user preferences, and the like.

In step 313, the processing platform 109 causes, at least in part, a recommendation of the one or more other media items, the at least one location, one or more other locations associated with the one or more other media files, or a combination thereof to the one or more other users. In one embodiment, the service provider 105 and/or the processing platform 109 present/recommend the one or more other media items to one or more other users. For example, a service provider may access one or more other media items at a user device and then present the one or more other media items to one or more other users so that the one or more other users may utilize the one or more other media items as part of their media collection, for planning a visit, and the like. In one embodiment, the service provider 105 and/or the processing platform 109 may recommend one or more other locations, one or more other POIs, and the like to the one or more other users. For example, a recommendation to visit a certain location, a certain POI, and the like.

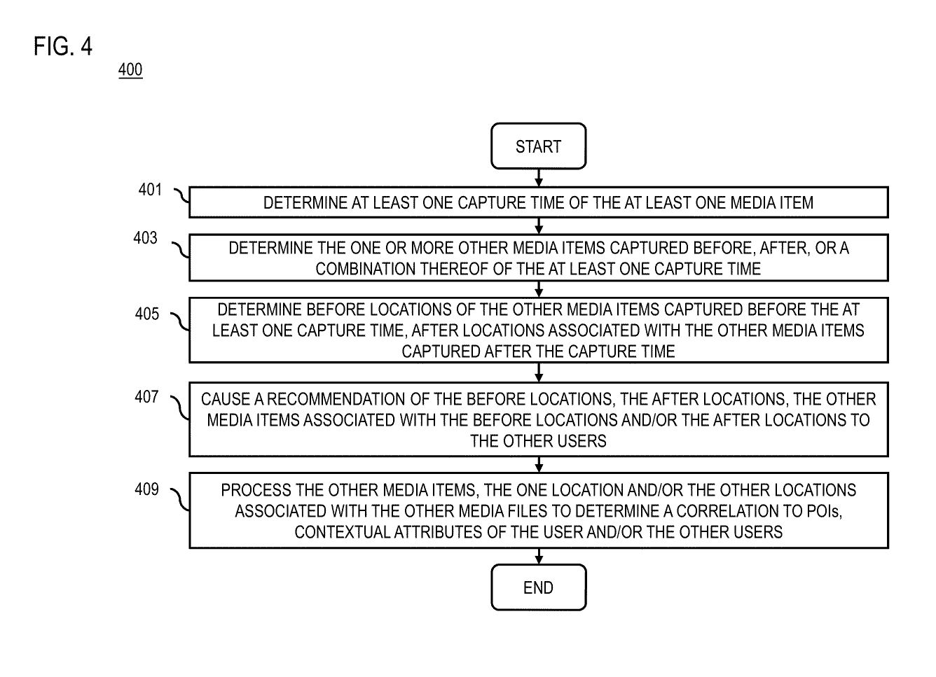

FIG. 4 is a flowchart of a process for, at least, determining one or more other media items, according to various embodiments. In one embodiment, the processing platform 109, the service provider 105 and/or the applications 103 perform the process 400 and are implemented in, for instance, a chip set including a processor and a memory as shown in FIG. 10. As such, the processing platform 109, the service provider 105, and/or the applications 103 can provide means for accomplishing various parts of the process 400 as well as means for accomplishing other processes in conjunction with other components of the system 100. Throughout this process, the processing platform 109 is referred to as completing various portions of the process 400, however, it is understood that other components of the system 100 can perform some of and/or all of the process steps. Further, in various embodiments, the processing platform 109 may be implemented in one or more entities of the system 100.

In step 401, the processing platform 109 determines at least one capture time of the at least one media item. In one embodiment, the service provider 105 and/or the processing platform 109 may determine a capture time, date (e.g., in a camera) of a media item, wherein the capture time may be determined from metadata associated with the one or more media items.

In step 403, the processing platform 109 determines the one or more other media items captured before, after, or a combination thereof of the at least one capture time. In one embodiment, the service provider 105 and/or the processing platform 109 may access a media collection (e.g., on a UE 101, at a media service, a digital album, etc.) and determine one or more other media items captured before and/or after the one media. For example, a media collection may include one or more media items captured before and/or after a selected media item based on listings, locations, themes, events, and the like.

In step 405, the processing platform 109 determines one or more before locations associated with the one or more other media items captured before the at least one capture time, one or more after locations associated with the one or more other media items captured after the at least one capture time, or a combination thereof. In one embodiment, the location information of the one or more before and/or after media items may be determined based on metadata associated with the media item and the one or more other media items. In one embodiment, the user may include one or more information items associated with the media item, the before and/or after media items.

In step 407, the processing platform 109 causes, at least in part, a recommendation of (a) the one or more before locations, the one or more after locations, or a combination thereof; (b) the one or more other media items associated with the one or more before locations, the one or more after locations, or a combination thereof; or (c) a combination thereof to the one or more other users. In one embodiment, the service provider 105 and/or the processing platform 109 may determine location information, event, theme, and the like for recommending one or more other media items, one or more locations, one or more events, and the like to one or more other users, wherein the one or more other users may be associated with the one or more locations, the one or more events, the one or more themes, and the like.

In step 409, the processing platform 109 processes and/or facilitates a processing of the one or more other media items, the at least one location, the one or more other locations associated with the one or more other media files, or a combination thereof to determine a correlation to (a) one or more points of interest, (b) one or more contextual attributes of the at least one user, the one or more other users, or a combination thereof; or (c) a combination thereof, wherein the recommendation of the one or more other media items, the at least one location, the one or more other locations associated with the one or more other media files, or a combination thereof is based, at least in part, on the correlation. In various embodiments, the service provider 105 and/or the processing platform 109 may determine one or more information items associated with the one or more media items, the one or more locations, one or more user information items (e.g., user profile, user preference, etc.), and the like and determine one or more comparable information items between the determined information, one or more POIs, one or more information associated with the user (e.g., user profile, nature of user travel, nature of user location, user preference, etc.) for the one or more other user based on the determined information.

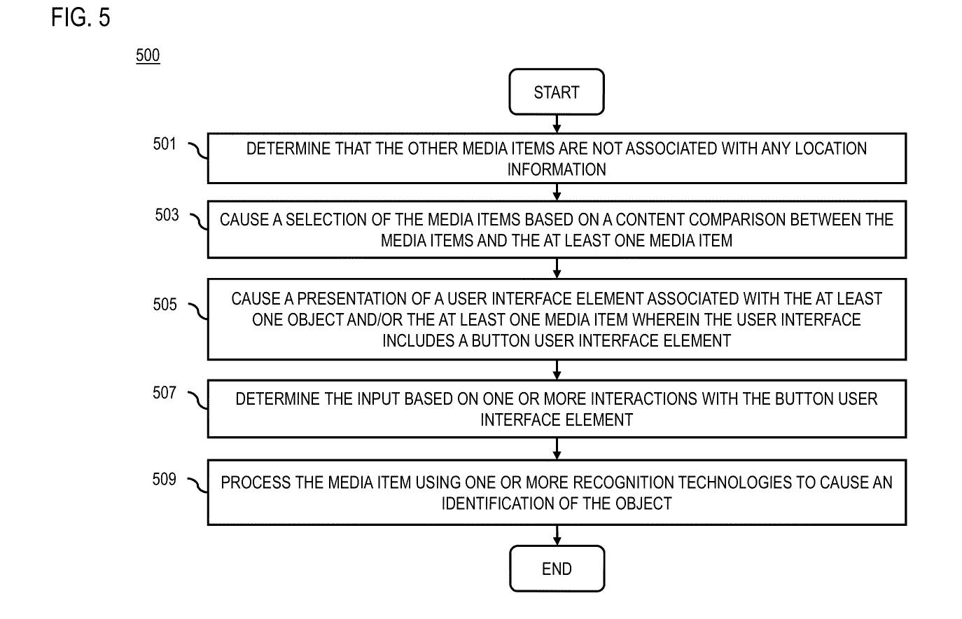

FIG. 5 is a flowchart of a process for, at least, determining one or more other media items, according to various embodiments. In one embodiment, the processing platform 109, the service provider 105 and/or the applications 103 perform the process 500 and are implemented in, for instance, a chip set including a processor and a memory as shown in FIG. 10. As such, the processing platform 109, the service provider 105, and/or the applications 103 can provide means for accomplishing various parts of the process 500 as well as means for accomplishing other processes in conjunction with other components of the system 100. Throughout this process, the processing platform 109 is referred to as completing various portions of the process 500, however, it is understood that other components of the system 100 can perform some of and/or all of the process steps. Further, in various embodiments, the processing platform 109 may be implemented in one or more entities of the system 100.

In step 501, the processing platform 109 determines that the one or more other media items are not associated with any location information. In one embodiment, the service provider 105 and/or the processing platform 109 may access one or more media collections, wherein one or more included media items are missing all or portions of metadata (e.g., location information).

In step 503, the processing platform 109 causes, at least in part, in a selection of the one or more media items based, at least in part, on a content comparison between the one or more media items and the at least one media item. In various embodiments, one or more content information items of a media item may be compared with that of one or more other media items. For example, the comparison may determine that one or more objects, users, themes, events, and the like are similar or dissimilar between the one media item and the one or more other media items.

In step 505, the processing platform 109 causes, at least in part, a presentation of at least one user interface element associated with the at least one object, the at least one media item, or a combination thereof, wherein the at least one user interface includes, at least in part, a button user interface element for indicating the association. In one embodiment, the service provider 105, the processing platform 109, and/or a UE 101 may present one or more UI elements for interaction with the user, for example, a hardware button, a software button, a touchscreen button, and the like, wherein the user may utilize the UI feature to make a selection, present an input, mark a media item, and the like. For example, the button may enable the user to indicate “I have been there,” “I am there,” “I will be there,” and the like associated with media item, an object in a media item, and the like.

In step 507, the processing platform 109 determines the input based, at least in part, on one or more interactions with the button user interface element. In one embodiment, the UI on the UE 101 may detect one or more inputs from the user, wherein the input may be associated with one or more media items, one or more information items, one or more use information, one or more user preferences, and the like. Further, the one or more inputs may be processed by the UE 101, the service provider 105 and/or the processing platform 109.

In step 509, the processing platform 109 processes and/or facilitates a processing of the at least one media item using one or more recognition technologies to cause, at least in part, an identification of the at least one object. In one embodiment, the UE 101, the service provider 105, and/or the processing platform 109 may utilize one or more object recognition algorithms, techniques, methods, and the like for identifying one or more objects in one or more media items. For example, the one or more recognition methods may be utilized along or instead of utilizing the metadata associated with one or more media items.

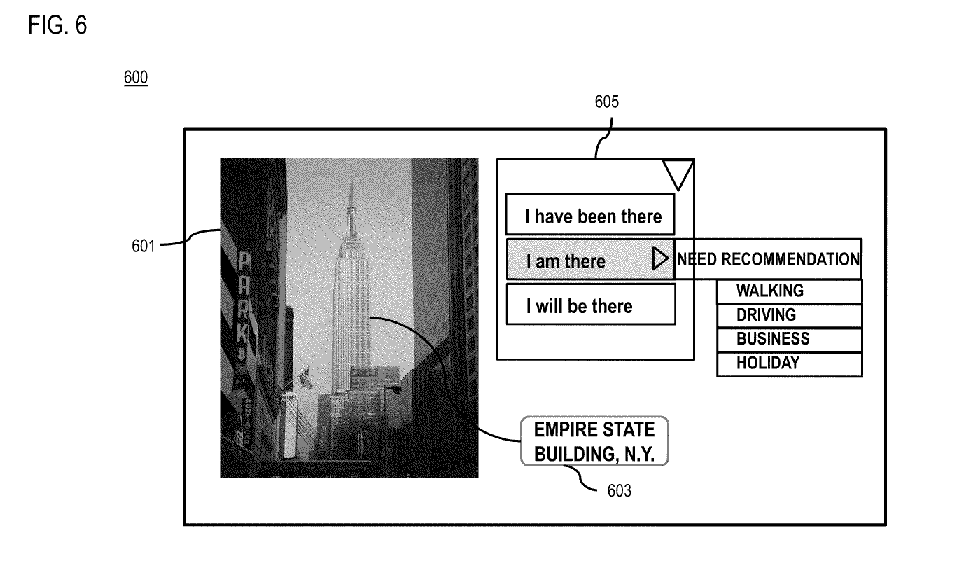

FIGS. 6-8 are diagrams of user interfaces utilized in the processes of FIGS. 3-5, according to various embodiments.

FIG. 6 shows a user interface 600 that displays media item 601. In various embodiments, the media item 601 may be submitted by a user (e.g., a digital image), may be presented to the user on a UE 101 (e.g., at a social networking site, on TV, etc.), may be viewed by the user (e.g., at a media service provider), may be captured by the user, and the like. In one embodiment, the service provider 105, the processing platform 109, and/or the applications 103 may process/analyze metadata associated with the media item 601 to determine one or more information items such as one or more objects in the media item (e.g., Empire State Building) and physical location of the object (e.g., N.Y.) 603, and the like. Further, the service provider 105, the processing platform 109, and/or the applications 103 may present UI elements 605 to the user for selecting one or more inputs indicative of, for example, “I have been there,” “I am there,” “I will be there.” The service provider 105, the processing platform 109, and/or the applications 103 may process one or more user inputs 605 in order to determine and perform various possible processes. For example, if the user selects “I have been there,” then the service provider 105, the processing platform 109, and/or the applications 103 may access and/or retrieve one or more other media items associated with the user and/or the media item 601 available at one or more local and/or remote storage devices, wherein the one or more media items may be sequentially, chronologically, and/or event-wise before and/or after the media item 601. In one embodiment, the user may select from the 605 options indicating “I am there,” which may cause the service provider 105 and/or the processing platform 109 to provide additional options for the user to request for one or more recommendations. For example, the user may specify one or more parameters such as that the one or more recommendations are for walking, driving and/or related to a business or a holiday event. In one embodiment, the user may indicate “I have been there,” wherein similar parameters may be queried from the user for association with the retrieved one or more media items. Furthermore, the user may select an option to indicate that “I will be there” (e.g., at the venue associated with the media item 601), wherein the service provider 105 and/or the processing platform 109 may determine one or more media items and/or recommendations associated with the venue of the media item 601 and one or more user criteria.

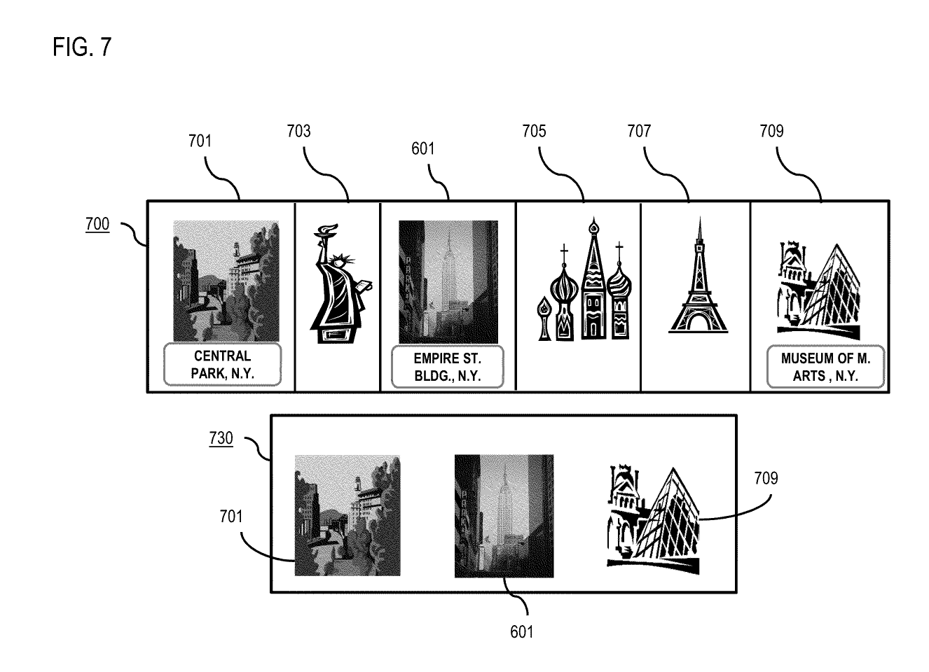

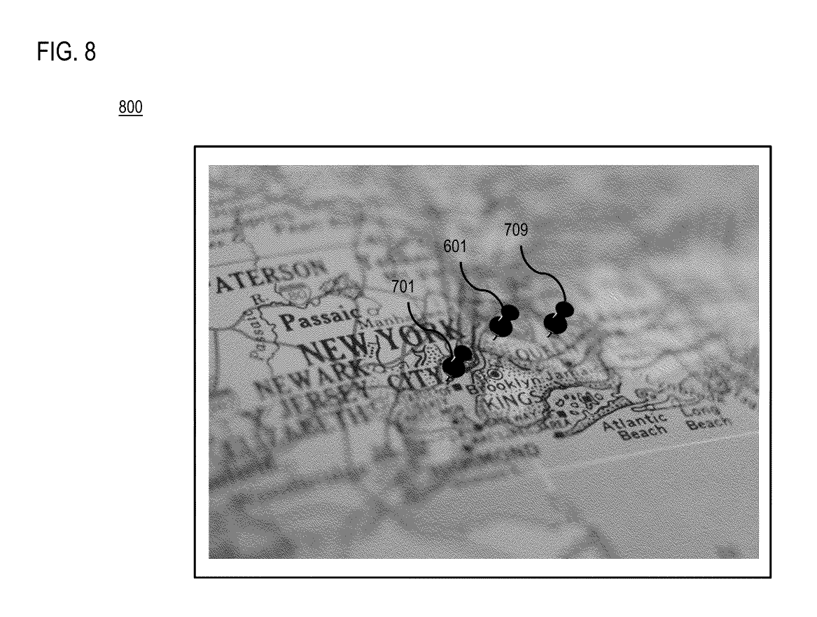

FIG. 7 shows media listing 700 and UI 730 depicting various media items. The media listing 700 shows various media items associated with a media collection of the user associated with the media item 601. In one embodiment, the service provider 105 and/or the processing platform 109 may request for permission to access one or more media collections of the user in order to determine one or more other media items: 701, 703, 705, 707, and 709, wherein metadata of the one or more other media items are processed in order to determine relevancy to the media item 601. For example, the one or more other media items may be in a sequential order or may be sorted by event, venue, date, time, and the like. I one embodiment, the relevant one or more other media items may be just before and/or after the media item 601. In one embodiment, the relevant one or more other media items 701 and 709 are not sequential to the media item 601. For example, the media items 703 and 705 (e.g., before and after the media item 601) are determined not to be relevant to the venue of the media item 601, which are listed in the UI 730 and presented to the user as a recommendation of venues to visit in that order. FIG. 8 shows a map application 800 including indicators 701, 601, and 709 corresponding to the venues of the same numerals, wherein one or more travel routes may be presented to the user.

The processes described herein for sharing, discovering, and/or recommending content items associated with user information and/or other content items may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

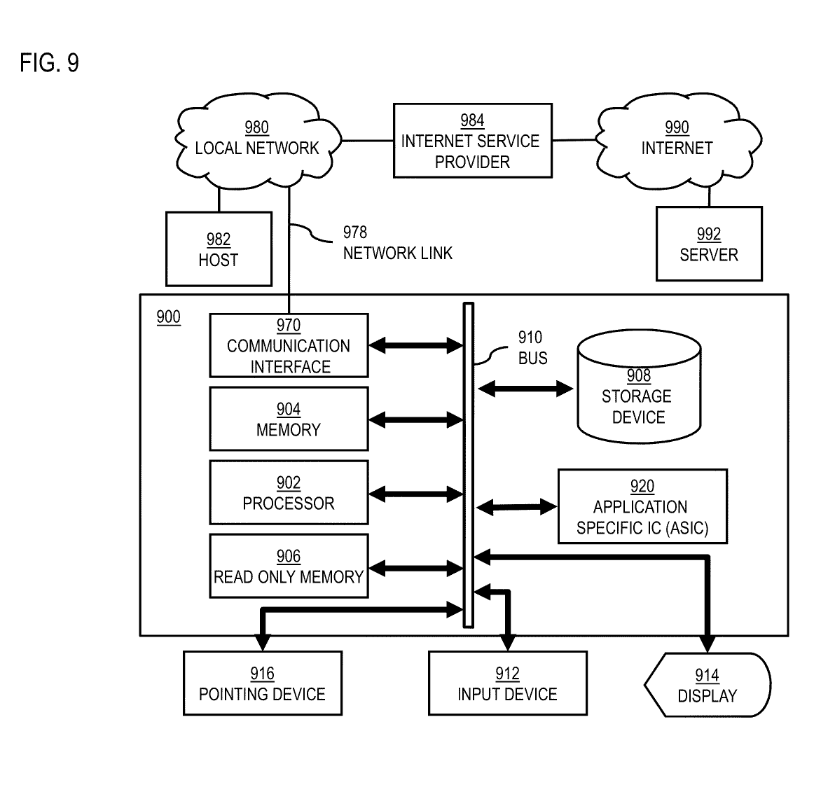

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to share, discover, and/or recommend content items associated with user information and/or other content items as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of sharing, discovering, and/or recommending content items associated with user information and/or other content items.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to sharing, discovering, and/or recommending content items associated with user information and/or other content items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for sharing, discovering, and/or recommending content items associated with user information and/or other content items. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for sharing, discovering, and/or recommending content items associated with user information and/or other content items, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914, and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic, or electromagnetic signals, including infrared and optical signals that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for sharing, discovering, and/or recommending content items associated with user information and/or other content items.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980, and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed sharing, discovering, and/or recommending content items associated with user information and/or other content items as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of sharing, discovering, and/or recommending content items associated with user information and/or other content items.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to share, discover, and/or recommend content items associated with user information and/or other content items. The memory 1005 also stores the data associated with or generated by the execution of the inventive steps.

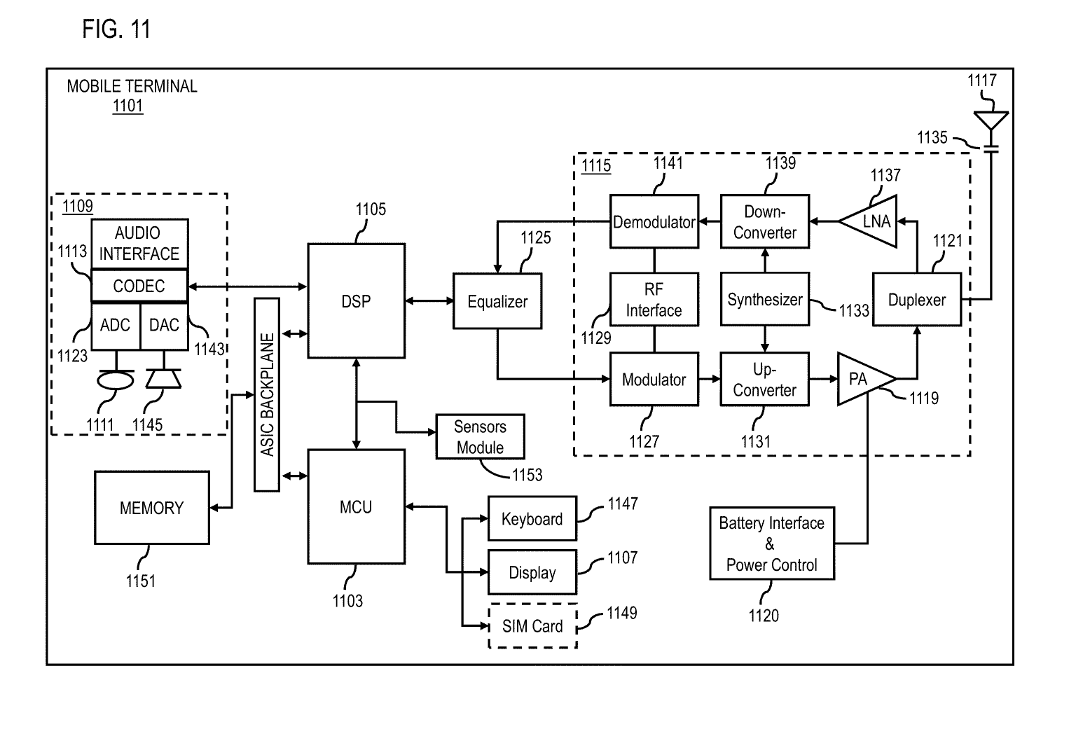

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of sharing, discovering, and/or recommending content items associated with user information and/or other content items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of sharing, discovering, and/or recommending content items associated with user information and/or other content items. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 for sharing, discovering, and/or recommending content items associated with user information and/or other content items. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of an input from at least one user for selecting at least one object depicted in at least one media item;
at least one determination of at least one location associated with the at least one object; and
an association of the at least one user with the at least one location.

2. A method of claim 1, wherein the (1) data and/or (2) information and/or (3) at least one signal are further based, at least in part, on the following:
at least one determination of one or more other media items based, at least in part, on the at least one location,
wherein the one or more other media items are from one or more media collections associated with the at least one user.

3. A method of claim 2, wherein the (1) data and/or (2) information and/or (3) at least one signal are further based, at least in part, on the following:
at least one determination of the one or more other media items based, at least in part, on a physical proximity criterion, a temporal proximity criterion, a thematic proximity criterion, a metadata similarity criterion, or a combination thereof.

4. A method of claim 2, wherein the (1) data and/or (2) information and/or (3) at least one signal are further based, at least in part, on the following:
at least one determination of one or more other respective associations between (a) the at least one media item, the one or more other media items, or a combination thereof; and (b) one or more other users; and
a recommendation of the one or more other media items, the at least one location, one or more other locations associated with the one or more other media files, or a combination thereof to the one or more other users.

5. A method of claim 4, wherein the (1) data and/or (2) information and/or (3) at least one signal are further based, at least in part, on the following:
at least one determination of at least one capture time of the at least one media item; and
at least one determination of the one or more other media items captured before, after, or a combination thereof of the at least one capture time.

6. A method of claim 5, wherein the (1) data and/or (2) information and/or (3) at least one signal are further based, at least in part, on the following:
at least one determination of one or more before locations associated with the one or more other media items captured before the at least one capture time, one or more after locations associated with the one or more other media items captured after the at least one capture time, or a combination thereof; and
a recommendation of (a) the one or more before locations, the one or more after locations, or a combination thereof; (b) the one or more other media items associated with the one or more before locations, the one or more after locations, or a combination thereof; or (c) a combination thereof to the one or more other users.

7. A method of claim 4, wherein the (1) data and/or (2) information and/or (3) at least one signal are further based, at least in part, on the following:
a processing of the one or more other media items, the at least one location, the one or more other locations associated with the one or more other media files, or a combination thereof to determine a correlation to (a) one or more points of interest, (b) one or more contextual attributes of the at least one user, the one or more other users, or a combination thereof; or (c) a combination thereof,
wherein the recommendation of the one or more other media items, the at least one location, the one or more other locations associated with the one or more other media files, or a combination thereof is based, at least in part, on the correlation.

8. A method of claim 1, wherein the (1) data and/or (2) information and/or (3) at least one signal are further based, at least in part, on the following:
at least one determination of that the one or more other media items is not associated with any location information; and
a selection of the one or more media items based, at least in part, on a content comparison between the one or more media items and the at least one media item.

9. A method of claim 1, wherein the (1) data and/or (2) information and/or (3) at least one signal are further based, at least in part, on the following:
a presentation of at least one user interface element associated with the at least one object, the at least one media item, or a combination thereof, wherein the at least one user interface includes, at least in part, a button user interface element for indicating the association; and
at least one determination of the input based, at least in part, on one or more interactions with the button user interface element.

10. A method of claim 1, wherein the (1) data and/or (2) information and/or (3) at least one signal are further based, at least in part, on the following:
a processing of the at least one media item using one or more recognition technologies to cause, at least in part, an identification of the at least one object.

11. An apparatus comprising:
at least one processor; and
at least one memory including computer program code for one or more programs,
the at least one memory and the computer program code configured to, with the at least one processor, cause the apparatus to perform at least the following,
determine an input from at least one user for selecting at least one object depicted in at least one media item;
determine at least one location associated with the at least one object; and
cause, at least in part, an association of the at least one user with the at least one location.

12. An apparatus of claim 11, wherein the apparatus is further caused to:
determine one or more other media items based, at least in part, on the at least one location,
wherein the one or more other media items are from one or more media collections associated with the at least one user.

13. An apparatus of claim 12, wherein the apparatus is further caused to:
determine the one or more other media items based, at least in part, on a physical proximity criterion, a temporal proximity criterion, a thematic proximity criterion, a metadata similarity criterion, or a combination thereof.

14. An apparatus of claim 12, wherein the apparatus is further caused to:
determine one or more other respective associations between (a) the at least one media item, the one or more other media items, or a combination thereof; and (b) one or more other users; and
cause, at least in part, a recommendation of the one or more other media items, the at least one location, one or more other locations associated with the one or more other media files, or a combination thereof to the one or more other users.

15. An apparatus of claim 14, wherein the apparatus is further caused to:
determine at least one capture time of the at least one media item; and
determine the one or more other media items captured before, after, or a combination thereof of the at least one capture time.

16. An apparatus of claim 15, wherein the apparatus is further caused to:
determine one or more before locations associated with the one or more other media items captured before the at least one capture time, one or more after locations associated with the one or more other media items captured after the at least one capture time, or a combination thereof; and
cause, at least in part, a recommendation of (a) the one or more before locations, the one or more after locations, or a combination thereof; (b) the one or more other media items associated with the one or more before locations, the one or more after locations, or a combination thereof; or (c) a combination thereof to the one or more other users.

17. An apparatus of claim 14, wherein the apparatus is further caused to:
process and/or facilitate a processing of the one or more other media items, the at least one location, the one or more other locations associated with the one or more other media files, or a combination thereof to determine a correlation to (a) one or more points of interest, (b) one or more contextual attributes of the at least one user, the one or more other users, or a combination thereof; or (c) a combination thereof,
wherein the recommendation of the one or more other media items, the at least one location, the one or more other locations associated with the one or more other media files, or a combination thereof is based, at least in part, on the correlation.

18. An apparatus of claim 11, wherein the apparatus is further caused to:
determine that the one or more other media items is not associated with any location information; and
cause, at least in part, in a selection of the one or more media items based, at least in part, on a content comparison between the one or more media items and the at least one media item.

19. An apparatus of claim 11, wherein the apparatus is further caused to:
cause, at least in part, a presentation of at least one user interface element associated with the at least one object, the at least one media item, or a combination thereof, wherein the at least one user interface includes, at least in part, a button user interface element for indicating the association; and
determine the input based, at least in part, on one or more interactions with the button user interface element.

20. An apparatus of claim 11, wherein the apparatus is further caused to:
process and/or facilitate a processing of the at least one media item using one or more recognition technologies to cause, at least in part, an identification of the at least one object.

21-48. (canceled)
